(19) United States
(12) Patent Application Publication
(10) Pub. No.: US 2024/0311560 A1
(43) Pub. Date: Sep. 19, 2024

(54) APPARATUS AND METHOD FOR DEEP LEARNING-BASED COREFERENCE RESOLUTION USING DEPENDENCY RELATION

(71) Applicant: ELECTRONICS AND TELECOMMUNICATIONS RESEARCH INSTITUTE, Daejeon (KR)

(72) Inventors: Joon Young Jung, Daejeon (KR); Dong-oh Kang, Daejeon (KR); Hwajeon Song, Daejeon (KR)

(21) Appl. No.: 18/595,675

(22) Filed: Mar. 5, 2024

(30) Foreign Application Priority Data
Mar. 14, 2023 (KR) 10-2023-0033208

(51) Int. Cl. G06F 40/205; G06N 3/0895

(52) U.S. Cl. CPC G06F 40/205; G06N 3/0895

(57) ABSTRACT

The present invention relates to an apparatus and method for deep learning-based coreference resolution using a dependency relation. An apparatus for deep learning-based coreference resolution according to the present invention includes a training data generation module that extracts one or more natural language sentences from a natural language paragraph and performs dependency parsing on the natural language sentences to generate dependency relation data of the natural language sentences, an embedding module that generates an integrated embedding vector for the natural language paragraph based on the natural language sentence and the dependency relation data, and a coreference resolution module that trains a deep learning neural network based on the integrated embedding vector and a first coreference mention preset for the natural language paragraph to generate a coreference resolution model.

### CROSS-REFERENCE TO RELATED APPLICATION

This application claims priority to and the benefit of Korean Patent Application No. 10-2023-0033208, filed on Mar. 14, 2023, the disclosure of which is incorporated herein by reference in its entirety.

### BACKGROUND

### 1. Field of the Invention

The present invention relates to a coreference resolution apparatus and method for recognizing mentions that have the same meaning from natural language text.

### 2. Description of Related Art

A large-scale knowledge base includes millions of knowledge and has been mainly used in the field of natural language processing. The existing constructed large-scale knowledge base needs to be expanded to include new knowledge. In order to efficiently add the latest knowledge to the knowledge base, knowledge should be automatically extracted from a large amount of recently collected data and added to the knowledge base. Structured data includes practical and useful information and is effective in extracting knowledge due to its structured structure, but a lot of new data exists in an unstructured form. Therefore, in order to extract new knowledge, it is necessary to effectively extract knowledge from natural language data in an unstructured form. In order to automatically extract knowledge from natural language sentences, a method of extracting a subject-predicate-object (SPO) tuple from natural language has been proposed. However, since the SPO tuple are extracted from a natural language sentence, a subject and an object extracted from the natural language sentence may include unclear information, and information with the same meaning may be expressed differently. To solve this problem, a coreference resolution method of recognizing multiple mentions that have the same meaning within a natural language paragraph has been proposed. However, there is a problem in that the existing coreference resolution method does not have high accuracy and are therefore not practical. Therefore, a coreference resolution method and apparatus having high accuracy are required.

### SUMMARY OF THE INVENTION

The present invention is directed to providing an apparatus and method for deep learning-based coreference resolution using a dependency relation that, in order to improve recognition accuracy for multiple mentions that have the same meaning in a natural language paragraph, generate the dependency relation from a natural language of coreference resolution data, generate an integrated embedding that integrates semantic and structure information of the natural language using data from pairs of natural languages and dependency relations, and perform a deep learning neural network calculation, mention detection, and coreference recognition using the generated integrated embedding.

An object of the present invention is not limited to the above-described aspect. That is, other objects that are not described may be obviously understood by those skilled in the art from the following specification.

According to an aspect of the present invention, there is provided an apparatus for deep learning-based coreference resolution using a dependency relation, including: a training data generation module that extracts one or more natural language sentences from a natural language paragraph, and performs dependency parsing on the natural language sentences to generate dependency relation data of the natural language sentences; an embedding module that generates an integrated embedding vector for the natural language paragraph based on the natural language sentence and the dependency relation data; and a coreference resolution module that trains a deep learning neural network based on the integrated embedding vector and a first coreference mention preset for the natural language paragraph to generate a coreference resolution model.

The training data generation module may include: a natural language sentence extraction unit that extracts the natural language sentence from the natural language paragraph; a dependency parsing unit that performs the dependency parsing on the natural language sentence; and a dependency relation extraction unit that generates the dependency relation data by extracting the dependency relation between words included in the natural language sentence based on a dependency parsing result of the dependency parsing unit.

The embedding module may include: a natural language embedding unit that embeds the words included in the natural language sentence to generate a natural language embedding vector; a dependency relation embedding unit that embeds the dependency relation data to generate a dependency relation embedding vector; and an integrated embedding unit that integrates the natural language embedding vector and the dependency relation embedding vector to generate the integrated embedding vector.

The coreference resolution module may include: a deep learning neural network calculation unit that inputs the integrated embedding vector to the deep learning neural network; a mention detection unit that detects a mention in the natural language paragraph based on a calculation result of the deep learning neural network; a coreference recognition unit that generates a second coreference mention of the natural language paragraph based on a result of the mention detection; and a training unit that trains the deep learning neural network based on the first coreference mention and the second coreference mention to generate the coreference resolution model.

The deep learning neural network may be a neural network based on a long short-term memory (LSTM).

The deep learning neural network may be a neural network based on bidirectional encoder representations from transformers (BERT).

The training unit may calculate a coreference recognition error between the first coreference mention and the second coreference mention, and train the deep learning neural network based on the error.

The training unit may calculate a coreference recognition error between the first coreference mention and the second coreference mention, and train a mention detection parameter of the mention detection unit based on the error.

The training unit may calculate a coreference recognition error between the first coreference mention and the second coreference mention, and train a coreference recognition parameter of the coreference recognition unit based on the error.

According to an aspect of the present invention, there is provided an apparatus for deep learning-based coreference resolution using a dependency relation, including: a first data storage that stores a natural language paragraph and a first coreference mention preset for the natural language paragraph; a second data storage; a training data generation module that extracts the natural language paragraph and the first coreference mention from the first data storage, extracts one or more natural language sentences from the natural language paragraph, performs dependency parsing on the natural language sentence to generate dependency relation data of the natural language sentence, and stores the natural language paragraph, the first coreference mention, the natural language sentence, and the dependency relation data in the second data storage; an embedding module that extracts the natural language sentence and the dependency relation data from the second data storage and generates an integrated embedding vector for the natural language paragraph based on the natural language sentence and the dependency relation data; and a coreference resolution module that trains a deep learning neural network based on the integrated embedding vector and the first coreference mention to generate a coreference resolution model.

The training data generation module may include: a natural language sentence extraction unit that extracts the natural language sentence from the natural language paragraph; a dependency parsing unit that performs the dependency parsing on the natural language sentence; and a dependency relation extraction unit that generates the dependency relation data by extracting the dependency relation between words included in the natural language sentence based on a dependency parsing result of the dependency parsing unit.

The embedding module may include: a natural language embedding unit that extracts the natural language sentence from the second data storage, and embeds words included in the natural language sentence to generate a natural language embedding vector; a dependency relation embedding unit that extracts the dependency relation data from the second data storage, and embeds the dependency relation data to generate a dependency relation embedding vector; and an integrated embedding unit that integrates the natural language embedding vector and the dependency relation embedding vector to generate the integrated embedding vector.

The coreference resolution module may include: a deep learning neural network calculation unit that inputs the integrated embedding vector to the deep learning neural network; a mention detection unit that detects a mention in the natural language paragraph based on a calculation result of the deep learning neural network; a coreference recognition unit that generates a second coreference mention of the natural language paragraph based on a result of the mention detection; and a training unit that trains the deep learning neural network based on the first coreference mention and the second coreference mention to generate the coreference resolution model.

The deep learning neural network may be a neural network based on an LSTM.

The deep learning neural network may be a neural network based on BERT.

The training unit may calculate a coreference recognition error between the first coreference mention and the second coreference mention, and train the deep learning neural network based on the error.

According to still another aspect of the present invention, there is provided a method of deep learning-based coreference resolution using a dependency relation, including: extracting one or more natural language sentences from a natural language paragraph, and performing dependency parsing on the natural language sentences to generate dependency relation data of the natural language sentences; generating an integrated embedding vector for the natural language paragraph based on the natural language sentence and the dependency relation data; and training a deep learning neural network based on the integrated embedding vector and a first coreference mention preset for the natural language paragraph to generate a coreference resolution model.

In the generating of the dependency relation data, the dependency relation data may be generated by extracting the dependency relation between words included in the natural language sentence based on a dependency parsing result.

In the generating of the coreference resolution model, the integrated embedding vector may be input to the deep learning neural network to generate a calculation result of the deep learning neural network, a mention may be detected in the natural language paragraph based on the calculation result, a second coreference mention of the natural language paragraph is generated based on a result of the mention detection, and the coreference resolution model may be generated by training the deep learning neural network based on the first coreference mention and the second coreference mention.

The method may further include inferring a third coreference mention for the natural language paragraph input by a user using the coreference resolution model.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a configuration of an apparatus for deep learning-based coreference resolution according to a first embodiment of the present invention;

FIG. 2 is a flowchart for describing a method of deep learning-based coreference resolution according to a first embodiment of the present invention;

FIG. 3 is a block diagram illustrating a configuration of an apparatus for deep learning-based coreference resolution according to a second embodiment of the present invention;

FIG. 4 is a flowchart for describing a method of deep learning-based coreference resolution according to a second embodiment of the present invention; and

FIG. 5 is a block diagram illustrating a computer system for implementing the method of deep learning-based coreference resolution according to the embodiment of the present invention.

### DETAILED DESCRIPTION OF EXEMPLARY EMBODIMENTS

The present invention relates to a coreference resolution device and method for recognizing mentions that have the same meaning from natural language text based on deep learning using a dependency relation. More specifically, the present invention relates to a method and apparatus for generating a dependency from a natural language of coreference resolution data, generating integrated embedding using data from pairs of natural language and dependency relation, and performing a deep learning neural network calculation, mention detection, and coreference recognition using the generated integrated embedding.

Various advantages and features of the present invention and methods accomplishing them will become apparent from the following description of embodiments with reference to the accompanying drawings. However, the present invention is not limited to exemplary embodiments to be described below, but may be implemented in various different forms, these embodiments will be provided only in order to make the present invention complete and allow those skilled in the art to completely recognize the scope of the present invention, and the present invention will be defined by the scope of the claims. Meanwhile, terms used in the present specification are for explaining exemplary embodiments rather than limiting the present invention. Unless otherwise stated, a singular form includes a plural form in the present specification. “Comprise” and/or “comprising” used in the present invention indicate(s) the presence of stated components, steps, operations, and/or elements but do(es) not exclude the presence or addition of one or more other components, steps, operations, and/or elements.

When it is decided that the detailed description of the known art related to the present invention may unnecessary obscure the gist of the present invention, a detailed description therefor will be omitted.

Hereinafter, embodiments of the present disclosure will be described in detail with reference to the accompanying drawings. The same means will be denoted by the same reference numerals throughout the accompanying drawings in order to facilitate the general understanding of the present invention in describing the present invention.

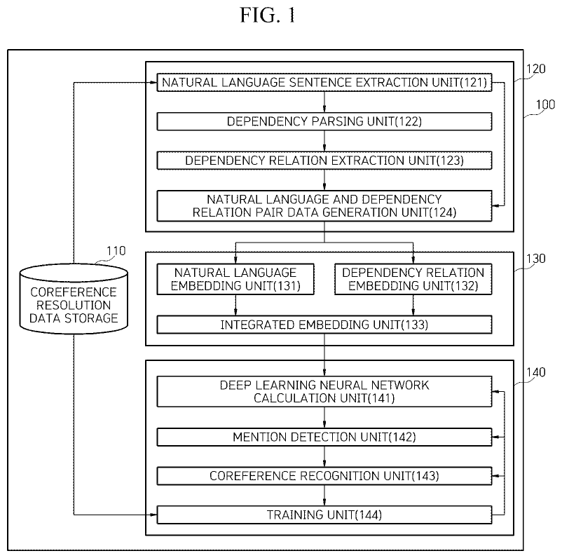

FIG. 1 is a block diagram illustrating a configuration of an apparatus for deep learning-based coreference resolution according to a first embodiment of the present invention.

An apparatus 100 for deep learning-based coreference resolution illustrated in FIG. 1 recognizes mentions that have the same meaning from natural language paragraph data using a deep learning model based on dependency relation. The apparatus 100 for deep learning-based coreference resolution includes a coreference resolution data storage 110, a training data generation module 120, an embedding module 130, and a coreference resolution module 140. Hereinafter, functions of each of the components 110, 120, 130, and 140 of the apparatus 100 for deep learning-based coreference resolution will be described in detail with reference to FIG. 1.

The apparatus 100 for deep learning-based coreference resolution illustrated in FIG. 1 is according to one embodiment, and the components of the apparatus for deep learning-based coreference resolution according to the present invention are limited to the embodiment illustrated in FIG. 1, and may be added, changed, or deleted, if necessary.

The coreference resolution data storage 110 stores data from pairs of natural language paragraphs and mention clusters (which may also be referred to as “coreference mention”). The data is used by the training unit 144 of the coreference resolution module 140 to train a deep learning model (e.g., deep learning neural network) according to a supervised learning method. For reference, the mention cluster is a cluster of mentions that have the same meaning in the natural language paragraph.

The training data generation module 120 generates data from pairs of natural language sentences and dependency relations based on a natural language paragraph in the coreference resolution data storage 110. The dependency relation refers to dependency relation between words included in the natural language sentence.

The training data generation module 120 includes a natural language sentence extraction unit 121, a dependency parsing unit 122, a dependency relation extraction unit 123, and a natural language and dependency relation pair data generation unit 124.

The natural language sentence extraction unit 121 receives a natural language paragraph from the coreference resolution data storage 110 and extracts a natural language sentence from the received natural language paragraph.

The dependency parsing unit 122 performs dependency parsing on the natural language sentence extracted by the natural language sentence extraction unit 121. This is for the structural analysis of the natural language sentence. The dependency parsing result includes the dependency relation.

The dependency relation extraction unit 123 generates dependency relation data based on the dependency parsing result of the dependency parsing unit 122. That is, the dependency relation extraction unit 123 extracts the dependency relation between the words included in the natural language sentence from the dependency parsing result.

The natural language and dependency relation pair data generation unit 124 generates and manages the data (hereinafter referred to as “natural language and dependency relation pair data”) of the pairs of the natural language sentences extracted from the natural language paragraph and the dependency relation data generated from the extracted natural language sentence.

The embedding module 130 generates an integrated embedding vector that includes the meaning of each word in the natural language paragraph and structure information of the natural language sentence included in the natural language paragraph based on the natural language and dependency relation pair data.

The natural language embedding unit 131 generates an embedding vector (hereinafter referred to as a “natural language embedding vector”) for natural language words included in the natural language and dependency relation pair data. The natural language embedding vector is generated to input the semantic information of the natural language to a deep learning neural network.

The dependency relation embedding unit 132 generates the embedding vector (hereinafter referred to as a “dependency relation embedding vector”) for the dependency relation included in the natural language and dependency relation pair data. The dependency relation embedding vector is generated to input the dependency relationship, which is the structure information of the natural language sentence, to the deep learning neural network.

The integrated embedding unit 133 is a vector (hereinafter referred to as an “integrated embedding vector”) that integrates the natural language embedding vector generated by the natural language embedding unit 131 and the dependency relation embedding vector generated by the dependency relation embedding unit 132 into one embedding vector. The integrated embedding vector includes the meaning and sentence structure information for each word in the natural language paragraph.

The coreference resolution module 140 trains the deep learning neural network based on the integrated embedding vector and data from pairs of natural language paragraphs and coreference mentions stored in the coreference resolution data storage 110 to generate a coreference resolution model.

The coreference resolution module 140 includes a deep learning neural network calculation unit 141, a mention detection unit 142, a coreference recognition unit 143, and a training unit 144.

The deep learning neural network calculation unit 141 receives the integrated embedding vector from the integrated embedding unit 133. The deep learning neural network calculation unit 141 performs a deep learning neural network calculation by inputting the integrated embedding vector to a deep learning neural network such as a long short-term memory (LSTM) or bidirectional encoder representations from transformers (BERT). The deep learning neural network will be described in detail later by being divided into a case based on the LSTM and a case based on the BERT.

When the deep learning neural network calculation unit 141 performs the LSTM-based deep learning neural network calculation, the LSTM-based deep learning neural network may be implemented as shown in Equation 1 to Equation 3.

$${\vec{h}}_{t}^{n} = H ( {W}_{{\vec{h}}^{n - 1} {\vec{h}}^{n}} {\vec{h}}_{t}^{n - 1} + {W}_{{\vec{h}}^{n} {\vec{h}}^{n}} {\vec{h}}_{t - 1}^{n} + {b}_{\vec{h}}^{n} ) \qquad [ Equation 1 ]$$

$${\overleftarrow{h}}_{t}^{n} = H ( {W}_{{\overleftarrow{h}}^{n - 1} {\overleftarrow{h}}^{n}} {\overleftarrow{h}}_{t}^{n - 1} + {W}_{{\overleftarrow{h}}^{n} {\overleftarrow{h}}^{n}} {\overleftarrow{h}}_{t + 1}^{n} + {b}_{\overleftarrow{h}}^{n} ) \qquad [ Equation 2 ]$$

$${h}_{t}^{N} = Φ ( {\vec{h}}_{t}^{N} , {\overleftarrow{h}}_{t}^{N} ) \qquad [ Equation 3 ]$$

The symbols in Equations 1 to 3 will be described. \vec{h}ₜⁿ denotes a forward hidden state at time step t of an n^{th} layer, and [symbol] denotes a backward hidden state at the time step t of the n^{th} layer. hₜ^{N} denotes a hidden state that integrates the forward hidden state \vec{h}ₜⁿ and the backward hidden state [symbol] at the time step t in the last layer (n^{th} layer). Φ denotes a function that updates the hidden state by integrating the forward and backward hidden states. For reference, H denotes a hidden state update function, W denotes a weight matrix, and b denotes a bias vector.

When the deep learning neural network calculation unit 141 performs the BERT-based deep learning neural network calculation, the BERT-based deep learning neural network may be implemented using an attention method such as Equation 4 to Equation 9.

$${q}_{t} = {x}_{t} \cdot {W}^{q} \qquad [ Equation 4 ]$$

$${k}_{t} = {x}_{t} \cdot {W}^{k} \qquad [ Equation 5 ]$$

$${v}_{t} = {x}_{t} \cdot {W}^{v} \qquad [ Equation 6 ]$$

$${s}_{t}^{n} = \frac{{q}_{t} \cdot {k}_{n}}{\sqrt{{d}_{k}}} , ( n ∈ ( 1 \sim N ) ) \qquad [ Equation 7 ]$$

$${v}_{t}^{n} = {v}_{n} \cdot \frac{exp ( {s}_{t}^{n} )}{{\sum }_{n = 1}^{N} exp ( {s}_{t}^{n} )} , ( n ∈ ( 1 \sim N ) ) \qquad [ Equation 8 ]$$

$${z}_{t} = concat ( {v}_{t}^{n} ) \cdot W ° , ( n ∈ ( 1 \sim N ) ) \qquad [ Equation 9 ]$$

The symbols in Equation 4 to Equation 9 will be described. qₜ denotes a t^{th} query, xₜ denotes t^{th} input embedding, W^{q} denotes a weight of the query, kₜ denotes a t^{th} key, W^{k} denotes a weight of a key, vₜ denotes a t^{th} value, and W^{v} denotes a weight of the value. Sₜⁿ denotes a value obtained by dividing a product of the t^{th} query and the n^{th} key kₙ by a square root of a key size dₖ. Vₜⁿ denotes a value obtained by multiplying a softmax value of the Sₜⁿ by an n^{th} value Vₙ, Zₜ denotes the t^{th} hidden state, and W^{o} denotes a weight for generating the hidden state. In Equations 7 to 9, n denotes a word index of a natural language paragraph. A concat function in Equation 9 is a function (concatenation) that combines vectors.

The mention detection unit 142 receives the deep learning neural network calculation results from the deep learning neural network calculation unit 141. The mention detection unit 142 generates a span (combination of words) in each natural language paragraph based on the deep learning neural network calculation result and detects a mention in the generated span.

The coreference recognition unit 143 uses a deep learning method based on the detected mention to recognize one mention (anaphora) and another mention (antecedent) with the same meaning. In the present invention, the anaphora may be a mention of interest, and the antecedent may be a mention with the same meaning as the anaphora. The coreference recognition unit 143 generates the coreference mention of the natural language paragraph based on the mention detection result of the mention detection unit 142.

The training unit 144 compares the coreference mention of the natural language paragraph generated by the coreference recognition unit 143 with the coreference mention of the natural language paragraph received from the coreference resolution data storage 110 to calculate coreference recognition accuracy and coreference recognition error. The training unit 144 performs deep learning-based coreference resolution training based on the calculated coreference recognition error. That is, the training unit 144 trains parameters of the deep learning neural network, mention detection parameters of the mention detection unit 142, and coreference recognition parameters of the coreference recognition unit 143 based on the coreference recognition error.

When the training of the parameters of the deep learning neural network of the coreference resolution module 140, the mention detection parameters of the mention detection unit 142, and the coreference recognition parameters of the coreference recognition unit 143 is completed, the apparatus 100 for deep learning-based coreference resolution may generate a coreference mention for an arbitrary natural language paragraph. That is, the training data generation module 120 generates the data from the pairs of natural language sentences and dependency relations based on the natural language paragraph that is the coreference resolution target, the embedding module 130 generate the integrated embedding vector based on the data from the pairs for the natural language paragraph, and the coreference resolution module 140 inputs the integrated embedding vector to the deep learning neural network, detects the mention based on the deep learning neural network calculation results, and generates the coreference mentions based on the mention detection result.

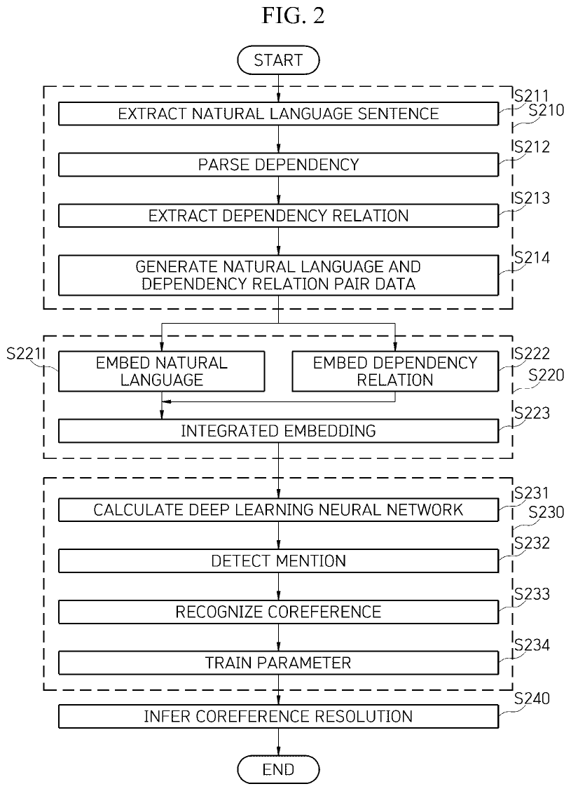

FIG. 2 is a flowchart for describing a method of deep learning-based coreference resolution according to a first embodiment of the present invention.

The method of deep learning-based coreference resolution according to the first embodiment of the present invention may be performed by the apparatus 100 for deep learning-based coreference resolution in FIG. 1.

The method of deep learning-based coreference resolution according to the first embodiment of the present invention may include operations S210 to S230, and may further include operation S240. The method of deep learning-based coreference resolution illustrated in FIG. 2 is according to one embodiment, and the operations of the method of deep learning-based coreference resolution according to the present invention are limited to the embodiment illustrated in FIG. 2, and may be added, changed, or deleted if necessary.

Operation S210 is a training data generation operation. The training data generation module 120 generates data from pairs of natural language sentences and dependency relations based on a natural language paragraph pre-stored in the coreference resolution data storage 110. Operation S210 includes operations S211 to S214.

Operation S211 is a natural language sentence extraction operation. The training data generation module 120 receives the pre-stored natural language paragraph from the coreference resolution data storage 110. The training data generation module 120 extracts the natural language sentence from the received natural language paragraph.

Operation S212 is a dependency parsing operation. The training data generation module 120 performs dependency parsing on the extracted natural language sentence.

Operation S213 is a dependency relation extraction operation. The training data generation module 120 extracts the dependency relation of the natural language sentence based on the dependency parsing result.

Operation S214 is a natural language and dependency relation pair data generation operation. The training data generation module 120 matches the extracted natural language sentence and the dependency relation generated based on the natural language sentence to generate and manage the natural language and dependency relation pair data.

Operation S220 is an embedding operation. The embedding module 130 generates an integrated embedding vector based on data from pairs of a plurality of natural language sentences and dependency relations corresponding to the training target natural language paragraph. Operation S220 includes operations S211 to S223.

Operation S221 is a natural language embedding operation. The embedding module 130 generates an embedding vector (natural language embedding vector) for a word included in the training target natural language paragraph.

Operation S222 is a dependency relation embedding operation. The embedding module 130 generates the embedding vector (dependency relation embedding vector) for the dependency relation of the training target natural language paragraph.

Operation S223 is an integrated embedding operation. The embedding module 130 integrates the natural language embedding vector and the dependency relation embedding vector to generate the integrated embedding vector for the training target natural language paragraph.

Operation S230 is a coreference resolution model training operation. The coreference resolution module 140 trains the deep learning neural network based on the integrated embedding vector and the coreference mention for the corresponding natural language paragraph pre-stored in the coreference resolution data storage 110 to generate the coreference resolution model. Operation S230 includes operations S231 to S234.

Operation S231 is a deep learning neural network calculation operation. The coreference resolution module 140 receives the integrated embedding vector for the training target natural language paragraph from the embedding module 130. The coreference resolution module 140 inputs the integrated embedding vector to the deep learning neural network to perform the deep learning neural network calculation.

Operation S232 is a mention detection operation. The coreference resolution module 140 detects the mention of the training target natural language paragraph based on the deep learning neural network calculation result.

Operation S233 is a coreference recognition operation. The coreference resolution module 140 generates the coreference mention of the training target natural language paragraph by recognizing other mentions (antecedent) that have the same meaning as one mention (anaphora) based on the detected mention.

Operation S234 is a parameter training operation. The coreference resolution module 140 compares the coreference mention of the training target natural language paragraph that is generated based on the detected mention with the coreference mention of the training target natural language paragraph pre-stored in the coreference resolution data storage 110 to determine the coreference recognition accuracy and the coreference recognition error. The coreference resolution module 140 uses the calculated coreference recognition error to train the deep learning neural network calculation, the mention detection parameters (parameters applied to the mention detection), and the coreference recognition parameters (parameters applied to the coreference recognition) to generate the coreference resolution model.

Operation S240 is a coreference resolution inference operation. The apparatus 100 for deep learning-based coreference resolution may generate the coreference mention using the coreference resolution model based on the natural language paragraph (natural language paragraph that is the coreference resolution target) given through user input, etc. The training data generation module 120 generates the data from the pairs of natural language sentences and dependency relations based on the natural language paragraph that is the coreference resolution target, the embedding module 130 generates the integrated embedding vector based on the data from the pairs of natural language sentences and dependency relations, and the coreference resolution module 140 inputs the integrated embedding vector to the deep learning neural network, detects the mention based on the deep learning neural network calculation result, and generates the coreference mention based on the mention detection result.

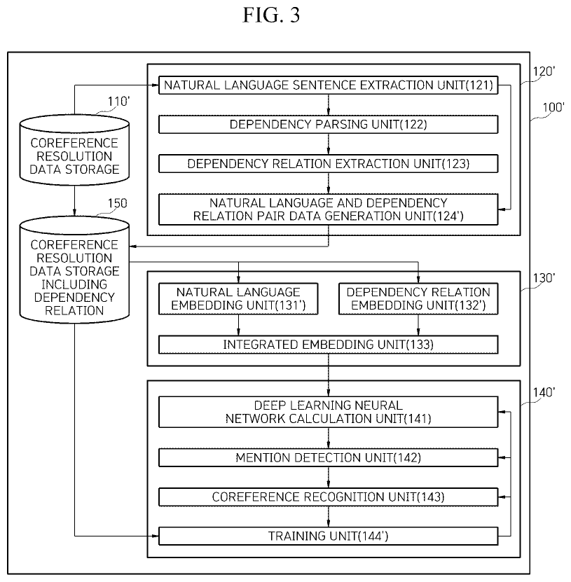

FIG. 3 is a block diagram illustrating a configuration of an apparatus for deep learning-based coreference resolution according to a second embodiment of the present invention.

Referring to FIG. 1, the apparatus 100 for deep learning-based coreference resolution according to the first embodiment of the present invention is designed to continuously perform a process of generating training data including a dependency relation and a process of training a deep learning model for coreference resolution. As illustrated in FIG. 3, an apparatus 100′ for deep learning-based coreference resolution according to a second embodiment of the present invention may separately perform a process of generating training data including a dependency relation and a process of training a deep learning model for coreference resolution.

The apparatus 100′ for deep learning-based coreference resolution includes a coreference resolution data storage 110′ (may be referred to as a “first data storage”), a training data generation module 120′, an embedding module 130′, and a coreference resolution module 140′, and a coreference resolution data storage 150 including a dependency relation (which may be referred to as a “second data storage”). The apparatus 100′ for deep learning-based coreference resolution further includes the coreference resolution data storage 150 including a dependency relation, compared to the apparatus 100 for deep learning-based coreference resolution 100, and proactively prepares training data using the coreference resolution data storage 150 including a dependency relation.

The apparatus 100′ for deep learning-based coreference resolution generates the deep learning-based coreference resolution training data including a dependency relation through the coreference resolution data storage 110′ and the training data generation module 120′, and generates the generated deep learning-based coreference resolution training data including a dependency relation in the coreference resolution data storage 150 including a dependency relation. The apparatus 100′ for deep learning-based coreference resolution stores all data of the coreference resolution data storage 110′ in the coreference resolution data storage 150 including a dependency relation.

The embedding module 130′ of the apparatus 100′ for deep learning-based coreference resolution generates the integrated embedding vector based on the training data stored in the coreference resolution data storage 150 including a dependency relation, and the coreference resolution module 140′ performs the deep learning-based coreference resolution training based on the integrated embedding vector and the coreference mention of the training target natural language paragraph that is stored in the coreference resolution data storage 150 including a dependency relation.

The specific differences between the apparatus 100′ for deep learning-based coreference resolution and the apparatus 100 for deep learning-based coreference resolution in FIG. 2 will be described below.

A natural language and dependency relation pair data generation unit 124′ stores all the data of the coreference resolution data storage 110′ in the coreference resolution data storage 150 including a dependency relation. The natural language and dependency relation pair data generation unit 124′ stores natural language and dependency relation pair data generated by the natural language and dependency relation pair data generation unit 124′ in the coreference resolution data storage 150 including a dependency relation.

The natural language embedding unit 131′ extracts words included in the plurality of natural language sentences corresponding to the training target natural language paragraph from the coreference resolution data storage 150 including a dependency relation. The natural language embedding unit 131′ generates the embedding vector (natural language embedding vector) for the words included in the training target natural language photograph.

The dependency relation embedding unit 132′ extracts the dependency relation corresponding to the training target natural language paragraph from the coreference resolution data storage 150 including a dependency relation. The dependency relation embedding unit 132′ generates the embedding vector (dependency relation embedding vector) for the extracted dependency relation.

The integrated embedding unit 133 integrates the natural language embedding vector and the dependency relation embedding vector to generate the integrated embedding vector for the training target natural language paragraph.

In the process of training the deep learning neural network, the training unit 144′ compares the coreference mention of the training target natural language paragraph generated based on the detected mention with the coreference mention of the training target natural language paragraph pre-stored in the coreference resolution data storage 150 including a dependency relation to calculate the coreference recognition accuracy and the coreference recognition error. The training unit 144′ uses the calculated coreference recognition error to train the parameters applied to the deep learning neural network calculation, the mention detection, and the coreference recognition, thereby generating the coreference resolution model.

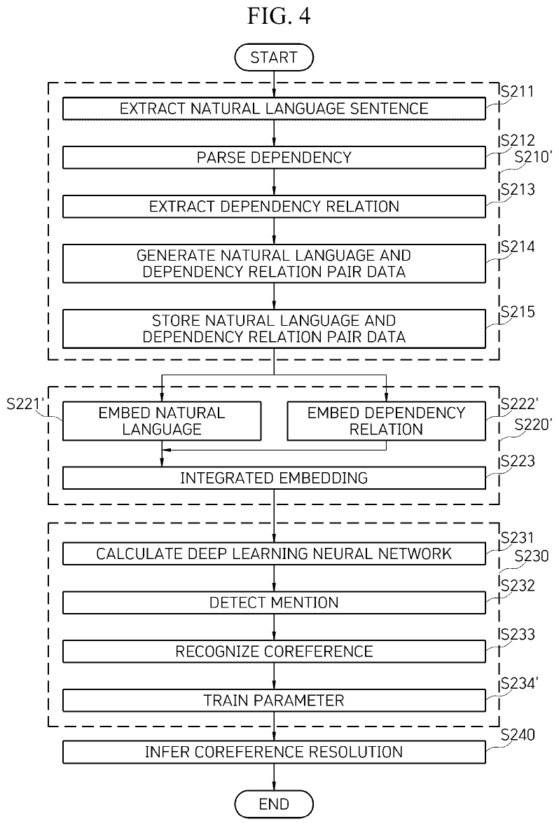

FIG. 4 is a flowchart for describing a method of deep learning-based coreference resolution according to a second embodiment of the present invention.

The method of deep learning-based coreference resolution according to the first embodiment of the present invention may be performed by the apparatus 100′ for deep learning-based coreference resolution in FIG. 3. The method of deep learning-based coreference resolution in FIG. 4 is a method in which the modules of the apparatus 100′ for deep learning-based coreference resolution illustrated in FIG. 3 precede the generation of the training data including the dependency relation.

The method of deep learning-based coreference resolution according to the second embodiment of the present invention may include operations S210′ to S230′, and may further include operation S240. The method of deep learning-based coreference resolution illustrated in FIG. 4 is according to one embodiment, and the operations of the method of deep learning-based coreference resolution according to the present invention are limited to the embodiment illustrated in FIG. 4, and may be added, changed, or deleted if necessary.

Operation S210′ is a training data generation and storing operation. The training data generation module 120′ generates the data from the pairs of natural language sentences and dependency relations (natural language and dependency relation pair data) based on the natural language paragraph pre-stored in the coreference resolution data storage 110′, and stores the natural language and dependency relation pair data in the coreference resolution data storage 150 including a dependency relation. Operation S210′ includes operations S211 to S214.

Since operations S211 to S214 are the same as the method of deep learning-based coreference resolution in FIG. 2, description thereof is omitted.

Operation S215 is a natural language and dependency relation pair data storing operation. The training data generation module 120′ stores all the data in the coreference resolution data storage 110′ in the coreference resolution data storage 150 including a dependency relation. The training data generation module 120′ stores the natural language and dependency relation pair data generated in operation S214 in the coreference resolution data storage 150 including a dependency relation.

Although not illustrated in FIG. 4, the training data generation module 120′ may repeatedly perform operations S211 to S215 to store all the data of the coreference resolution data storage 110′ (including the data from the pairs of natural language paragraphs and coreference mentions) and the natural language and dependency relation pair data for each natural language paragraph in the coreference resolution data storage 150 including a dependency relation.

Operation S220′ is an embedding operation. The embedding module 130′ extracts data from pairs of a plurality of natural language sentences and dependency relations (natural language and dependency relation pair data) corresponding to the training target natural language paragraph from the coreference resolution data storage 150 including a dependency relation, and generates the integrated embedding vector based on the extracted natural language and dependency relation pair data. Operation S220′ includes operations S221′, S222′, and S223.

Operation S221′ is a natural language embedding operation. The embedding module 130′ extracts words included in the plurality of natural language sentences corresponding to the training target natural language paragraph from the coreference resolution data storage 150 including a dependency relation. The embedding module 130′ generates an embedding vector (natural language embedding vector) for a word included in the training target natural language paragraph.

Operation S222′ is a dependency relation embedding operation. The embedding module 130′ extracts the dependency relation corresponding to the training target natural language paragraph from the coreference resolution data storage 150 including a dependency relation. The embedding module 130′ generates the embedding vector (dependency relation embedding vector) for the extracted dependency relation.

Operation S223 is an integrated embedding operation. The embedding module 130′ integrates the natural language embedding vector and the dependency relation embedding vector to generate the integrated embedding vector for the training target natural language paragraph.

Operation S230′ is a coreference resolution model training operation. The coreference resolution module 140′ trains the deep learning neural network based on the integrated embedding vector and the coreference mention for the corresponding natural language paragraph pre-stored in the coreference resolution data storage 150 to generate the coreference resolution model. Operation S230′ includes operations S231 to S233 and S234′.

Since operations S231 to S233 are the same as the method of deep learning-based coreference resolution in FIG. 2, description thereof is omitted.

Operation S234′ is a parameter training operation. The coreference resolution module 140′ compares the coreference mention of the training target natural language paragraph that is generated based on the detected mention with the coreference mention of the training target natural language paragraph pre-stored in the coreference resolution data storage 150 including a dependency relation to determine the coreference recognition accuracy and the coreference recognition error.

The coreference resolution module 140′ uses the calculated coreference recognition error to train the parameters applied to the deep learning neural network calculation, the mention detection, and the coreference recognition, thereby generating the coreference resolution model.

Since operation S240 is the same as the method of deep learning-based coreference resolution in FIG. 2, description thereof is omitted.

The method of deep learning-based coreference resolution according to the first and second embodiments of the present invention described above was described with reference to the flowcharts illustrated in FIGS. 2 and 4. For simplicity, the method has been illustrated and described as a series of blocks, but the invention is not limited to the order of the blocks, and some blocks may occur with other blocks in a different order or at the same time as illustrated and described in the present specification. Also, various other branches, flow paths, and orders of blocks that achieve the same or similar result may be implemented. In addition, all the illustrated blocks may not be required for implementation of the methods described in the present specification.

Meanwhile, in the description with reference to FIGS. 2 and 4, each operation may be further divided into additional operations or combined into fewer operations according to an implementation example of the present invention. Also, some steps may be omitted if necessary, and an order between the steps may be changed. In addition, the contents of FIGS. 1 and 3 may be applied to the contents of FIGS. 2 and 4 even if other contents are omitted. In addition, the contents of FIGS. 2 and 3 may be applied to the contents of FIGS. 1 and 3.

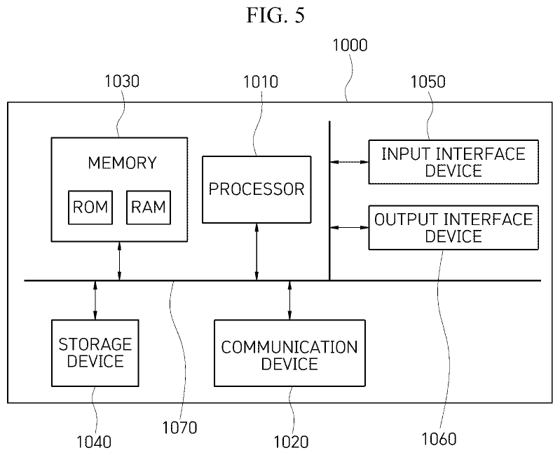

FIG. 5 is a block diagram illustrating a computer system for implementing the method of deep learning-based coreference resolution according to the embodiment of the present invention. The method of deep learning-based coreference resolution of FIG. 2 or FIG. 4 may be performed through the computer system of FIG. 5. In addition, the apparatus 100 for deep learning-based coreference resolution of FIG. 1 or the apparatus 100′ for deep learning-based coreference resolution of FIG. 3 may be implemented in the form of the computer system of FIG. 5.

Referring to FIG. 5, a computer system 1000 may include at least one of a processor 1010, a memory 1030, an input interface device 1050, an output interface device 1060, and a storage device 1040 that communicate through a bus 1070. The computer system 1000 may further include a communication device 1020 coupled to a network. The processor 1010 may be a central processing unit (CPU) or a semiconductor device that executes instructions stored in the memory 1030 or the storage device 1040. The memory 1030 and the storage device 1040 may include various types of volatile or non-volatile storage media. For example, the memory may include a read only memory (ROM) and a random access memory (RAM). In the embodiment of the present disclosure, the memory may be located inside or outside the processing unit, and the memory may be connected to the processing unit through various known means. The memory may be various types of volatile or non-volatile storage media, and the memory may include, for example, a ROM or a RAM.

Accordingly, the embodiment of the present invention may be implemented as a computer-implemented method, or as a non-transitory computer-readable medium having computer-executable instructions stored thereon. In one embodiment, when executed by the processing unit, the computer-readable instructions may perform the method according to at least one aspect of the present disclosure.

Meanwhile, the storage device 1040 may include a plurality of stores (or database). For example, the storage device 1040 may include the coreference resolution data storage 110′ described above and the coreference resolution data storage 150 including a dependency relation.

The communication device 1020 may transmit or receive a wired signal or a wireless signal.

In addition, the method according to the embodiment of the present invention may be implemented in the form of program instructions that may be executed through various computer means and may be recorded in a computer-readable recording medium.

The computer-readable recording medium may include a program instruction, a data file, a data structure or the like, alone or a combination thereof. The program instructions recorded in the computer-readable recording medium may be configured by being especially designed for the embodiment of the present invention, or may be used by being known to those skilled in the field of computer software. The computer-readable recording medium may include a hardware device configured to store and execute the program instructions. Examples of the computer-readable recording medium may include magnetic media such as a hard disk, a floppy disk, and a magnetic tape, optical media such as a compact disk read only memory (CD-ROM) or a digital versatile disk (DVD), magneto-optical media such as a floptical disk, a ROM, a RAM, a flash memory, or the like. Examples of the program instructions may include a high-level language code capable of being executed by a computer using an interpreter, or the like, as well as a machine language code made by a compiler.

Hereinafter, the results of performing the supervised learning of the deep learning neural network and performing the coreference resolution on the natural language paragraph using the apparatus and method for deep learning-based coreference resolution using a dependency relation according to the present invention will be described.

In the case where the LSTM is used as the deep learning neural network, the coreference resolution results when not using the dependency relation and when using the dependency relation are compared. Table 1 shows the coreference resolution results when using the LSTM as the deep learning neural network and when not using the dependency relation, and Table 2 shows the coreference resolution result when using the dependency relation in the case where the LSTM is used as the deep learning neural network. As performance evaluation criteria, Precision, Recall, and F1 values of MUC, B3, and CEAF were used. As the comparison results, an Average F1 value when using the dependency relation (Table 2) is 73.30, which is higher than the Average F1 value (73.0) when not using the dependency relation (Table 1), so it can be seen that the performance when using the dependency relation is better than when not using the dependency relation.

TABLE 1

| MUC | | | B³ | | | CEAF | | | Ave. |
|---|---|---|---|---|---|---|---|---|---|
| Pre. | Rec. | F1 | Pre. | Rec. | F1 | Pre. | Rec. | F1 | F1 |
| 81.4 | 79.5 | 80.4 | 72.2 | 69.5 | 70.8 | 68.2 | 67.1 | 67.6 | 73.0 |

TABLE 2

| MUC | | | B³ | | | CEAF | | | Ave. |
|---|---|---|---|---|---|---|---|---|---|
| Pre. | Rec. | F1 | Pre. | Rec. | F1 | Pre. | Rec. | F1 | F1 |
| 81.80 | 78.31 | 80.01 | 73.30 | 69.75 | 71.88 | 69.26 | 66.84 | 68.02 | 73.30 |

In the case where the BERT is used as the deep learning neural network, the coreference resolution results when not using the dependency relation and when using the dependency relation are compared. Table 3 shows the coreference resolution result when not using the dependency relation, and Table 4 shows the coreference resolution result when using the dependency relation. As the performance evaluation criteria, Precision, Recall, and F1 values of MUC, B3, and CEAF were used. As the comparison results, an Average F1 value when using the dependency relation (Table 4) is 74.92, which is higher than the Average F1 value (73.9) when not using the dependency relation (Table 3), so it can be seen that the performance when using the dependency relation is better than when not using the dependency relation.

TABLE 3

| MUC | | | B³ | | | CEAF | | | Ave. |
|---|---|---|---|---|---|---|---|---|---|
| Pre. | Rec. | F1 | Pre. | Rec. | F1 | Pre. | Rec. | F1 | F1 |
| 80.2 | 82.4 | 81.3 | 69.6 | 73.8 | 71.6 | 69.0 | 68.6 | 68.8 | 73.9 |

TABLE 4

| MUC | | | B³ | | | CEAF | | | Ave. |
|---|---|---|---|---|---|---|---|---|---|
| Pre. | Rec. | F1 | Pre. | Rec. | F1 | Pre. | Rec. | F1 | F1 |
| 83.72 | 79.42 | 81.51 | 75.25 | 71.32 | 73.24 | 71.8 | 68.33 | 70.02 | 74.92 |

In the case where BERT is largely used as the deep learning neural network, the coreference resolution results when not using the dependency relation and when using the dependency relation are compared. Table 5 shows the coreference resolution result when not using the dependency relation, and Table 6 shows the coreference resolution result when using the dependency relation. As the performance evaluation criteria, Precision, Recall, and F1 values of MUC, B3, and CEAF were used. As the comparison results, an Average F1 value when using the dependency relation (Table 6) is 77.77, which is higher than the Average F1 value (76.9) when not using the dependency relation (Table 5), so it can be seen that the performance when using the dependency relation is better than when not using the dependency relation.

TABLE 5

| MUC | | | B³ | | | CEAF | | | Ave. |
|---|---|---|---|---|---|---|---|---|---|
| Pre. | Rec. | F1 | Pre. | Rec. | F1 | Pre. | Rec. | F1 | F1 |
| 84.7 | 82.4 | 83.5 | 76.5 | 74.0 | 75.3 | 74.1 | 69.8 | 71.9 | 76.9 |

TABLE 6

| MUC | | | B³ | | | CEAF | | | Ave. |
|---|---|---|---|---|---|---|---|---|---|
| Pre. | Rec. | F1 | Pre. | Rec. | F1 | Pre. | Rec. | F1 | F1 |
| 86.22 | 81.38 | 83.73 | 79.48 | 73.46 | 76.35 | 75.71 | 70.92 | 73.24 | 77.77 |

In the case where SpanBERT is used as the deep learning neural network, the coreference resolution results when not using the dependency relation and when using the dependency relation are compared. Table 7 shows the coreference resolution result when not using the dependency relation, and Table 8 shows the coreference resolution result when using the dependency relation. As the performance evaluation criteria, Precision, Recall, and F1 values of MUC, B3, and CEAF were used. As the comparison results, an Average F1 value when using the dependency relation (Table 8) is 80.5, which is higher than the Average F1 value (79.6) when not using the dependency relation (Table 7), so it can be seen that the performance when using the dependency relation is better than when not using the dependency relation.

TABLE 7

| MUC | | | B³ | | | CEAF | | | Ave. |
|---|---|---|---|---|---|---|---|---|---|
| Pre. | Rec. | F1 | Pre. | Rec. | F1 | Pre. | Rec. | F1 | F1 |
| 85.8 | 84.8 | 85.3 | 78.3 | 77.9 | 78.1 | 76.4 | 74.2 | 75.3 | 79.6 |

TABLE 8

| MUC | | | B³ | | | CEAF | | | Ave. |
|---|---|---|---|---|---|---|---|---|---|
| Pre. | Rec. | F1 | Pre. | Rec. | F1 | Pre. | Rec. | F1 | F1 |
| 86.9 | 84.2 | 85.6 | 81.2 | 78 | 79.6 | 77.9 | 75.1 | 76.5 | 80.5 |

For reference, the components according to the embodiment of the present invention may be implemented in the form of software or hardware such as a digital signal processor (DSP), a field programmable gate array (FPGA), or an application specific integrated circuit (ASIC), and perform predetermined roles.

However, “components” are not limited to software or hardware, and each component may be configured to be in an addressable storage medium or to reproduce one or more processors.

Accordingly, for example, the component includes components such as software components, object-oriented software components, class components, and task components, processors, functions, attributes, procedures, subroutines, segments of a program code, drivers, firmware, a microcode, a circuit, data, a database, data structures, tables, arrays, and variables.

Components and functions provided within the components may be combined into a smaller number of components or further divided into additional components.

Meanwhile, it will be appreciated that each block of a processing flowchart and combinations of the flowcharts may be executed by computer program instructions. Since these computer program instructions may be mounted in a processor of a general computer, a special computer, or other programmable data processing apparatuses, these computer program instructions executed through the process of the computer or the other programmable data processing apparatuses create means performing functions described in a block (s) of the flow chart. Since the computer program instructions may also be mounted on the computer or the other programmable data processing apparatuses, the instructions performing a series of operation steps on the computer or the other programmable data processing apparatuses to create processes executed by the computer, thereby executing the computer or the other programmable data processing apparatuses may also provide steps for performing the functions described in a block(s) of the flowchart.

In addition, each block may indicate some of modules, segments, or codes including one or more executable instructions for executing a specific logical function (specific logical functions). Further, it is to be noted that functions mentioned in the blocks occur regardless of a sequence in some alternative embodiments. For example, two blocks that are continuously illustrated may be simultaneously performed or be performed in a reverse sequence depending on corresponding functions.

The term “˜unit” or “˜module” used in the specification refers to a software component or a hardware component such as FPGA or ASIC, and the “˜unit” or “˜module” performs certain roles. However, the term “˜unit” or “module” is not meant to be limited to software or hardware. The “˜unit” or “module” may be configured to be stored in a storage medium that can be addressed or may be configured to regenerate one or more processors. Accordingly, as an example, the “˜unit” or “module” refers to components such as software components, object-oriented software components, class components, and task components, processes, functions, attributes, procedures, subroutines, segments of program code, drivers, firmware, microcode, circuits, data, databases, data structures, tables, arrays and variables. Functions provided in components, and the “˜unit” or “˜modules” may be combined into fewer components, and “˜unit” or “˜modules” or further separated into additional components, and “˜unit” or “˜modules.” In addition, components and “˜or/er” or “˜modules” may be implemented to play one or more CPUs in a device or a secure multimedia card.

According to an embodiment of the present invention, by generating the dependency relation of the natural language sentence, generating the embedding that integrates the semantic and structure information of the natural language, and performing the deep learning-based coreference resolution using the integrated embedding, it is possible to improve the accuracy of the coreference resolution in the natural language paragraph.

In addition, according to an embodiment of the present invention, since the learning of the deep learning model is performed including the structure of the natural language sentence, it is possible to apply the deep learning-based coreference resolution model trained in the specific domain to training in another domain.

Effects which can be achieved by the present invention are not limited to the above-described effects. That is, other objects that are not described may be obviously understood by those skilled in the art to which the present invention pertains from the following description.

Although exemplary embodiments of the present invention have been disclosed above, it may be understood by those skilled in the art that the present invention may be variously modified and changed without departing from the scope and spirit of the present invention described in the following claims.

What is claimed is:

1. An apparatus for deep learning-based coreference resolution, comprising:
a training data generation module that extracts one or more natural language sentences from a natural language paragraph and performs dependency parsing on the natural language sentences to generate dependency relation data of the natural language sentences;
an embedding module that generates an integrated embedding vector for the natural language paragraph based on the natural language sentence and the dependency relation data; and
a coreference resolution module that trains a deep learning neural network based on the integrated embedding vector and a first coreference mention preset for the natural language paragraph to generate a coreference resolution model.

2. The apparatus of claim 1, wherein the training data generation module includes:
a natural language sentence extraction unit that extracts the natural language sentence from the natural language paragraph;
a dependency parsing unit that performs the dependency parsing on the natural language sentence; and
a dependency relation extraction unit that generates the dependency relation data by extracting the dependency relation between words included in the natural language sentence based on a dependency parsing result of the dependency parsing unit.

3. The apparatus of claim 1, wherein the embedding module includes:
a natural language embedding unit that embeds the words included in the natural language sentence to generate a natural language embedding vector;
a dependency relation embedding unit that embeds the dependency relation data to generate a dependency relation embedding vector; and
an integrated embedding unit that integrates the natural language embedding vector and the dependency relation embedding vector to generate the integrated embedding vector.

4. The apparatus of claim 1, wherein the coreference resolution module includes:
a deep learning neural network calculation unit that inputs the integrated embedding vector to the deep learning neural network;
a mention detection unit that detects a mention in the natural language paragraph based on a calculation result of the deep learning neural network;
a coreference recognition unit that generates a second coreference mention of the natural language paragraph based on a result of the mention detection; and
a training unit that trains the deep learning neural network based on the first coreference mention and the second coreference mention to generate the coreference resolution model.

5. The apparatus of claim 1, wherein the deep learning neural network is a neural network based on a long short-term memory (LSTM).

6. The apparatus of claim 1, wherein the deep learning neural network is a neural network based on bidirectional encoder representations from transformers (BERT).

7. The apparatus of claim 4, wherein the training unit calculates a coreference recognition error between the first coreference mention and the second coreference mention, and trains the deep learning neural network based on the error.

8. The apparatus of claim 4, wherein the training unit calculates a coreference recognition error between the first coreference mention and the second coreference mention, and trains a mention detection parameter of the mention detection unit based on the error.

9. The apparatus of claim 4, wherein the training unit calculates a coreference recognition error between the first coreference mention and the second coreference mention, and trains a coreference recognition parameter of the coreference recognition unit based on the error.

10. An apparatus for deep learning-based coreference resolution, comprising:
a first data storage that stores a natural language paragraph and a first coreference mention preset for the natural language paragraph;
a second data storage;
a training data generation module that extracts the natural language paragraph and the first coreference mention from the first data storage, extracts one or more natural language sentences from the natural language paragraph, performs dependency parsing on the natural language sentence to generate dependency relation data of the natural language sentence, and stores the natural language paragraph, the first coreference mention, the natural language sentence, and the dependency relation data in the second data storage;
an embedding module that extracts the natural language sentence and the dependency relation data from the second data storage and generates an integrated embedding vector for the natural language paragraph based on the natural language sentence and the dependency relation data; and
a coreference resolution module that trains a deep learning neural network based on the integrated embedding vector and the first coreference mention to generate a coreference resolution model.

11. The apparatus of claim 10, wherein the training data generation module includes:
a natural language sentence extraction unit that extracts the natural language sentence from the natural language paragraph;
a dependency parsing unit that performs the dependency parsing on the natural language sentence; and
a dependency relation extraction unit that generates the dependency relation data by extracting the dependency relation between words included in the natural language sentence based on a dependency parsing result of the dependency parsing unit.

12. The apparatus of claim 10, wherein the embedding module includes:
a natural language embedding unit that extracts the natural language sentence from the second data storage, and embeds words included in the natural language sentence to generate a natural language embedding vector;
a dependency relation embedding unit that extracts the dependency relation data from the second data storage and embeds the dependency relation data to generate a dependency relation embedding vector; and
an integrated embedding unit that integrates the natural language embedding vector and the dependency relation embedding vector to generate the integrated embedding vector.

13. The apparatus of claim 10, wherein the coreference resolution module includes:
a deep learning neural network calculation unit that inputs the integrated embedding vector to the deep learning neural network;
a mention detection unit that detects a mention in the natural language paragraph based on a calculation result of the deep learning neural network;
a coreference recognition unit that generates a second coreference mention of the natural language paragraph based on a result of the mention detection; and
a training unit that trains the deep learning neural network based on the first coreference mention and the second coreference mention to generate the coreference resolution model.

14. The apparatus of claim 10, wherein the deep learning neural network is a neural network based on a long short-term memory (LSTM).

15. The apparatus of claim 10, wherein the deep learning neural network is a neural network based on bidirectional encoder representations from transformers (BERT).

16. The apparatus of claim 13, wherein the training unit calculates a coreference recognition error between the first coreference mention and the second coreference mention, and trains the deep learning neural network based on the error.

17. A method of deep learning-based coreference resolution, comprising:
extracting one or more natural language sentences from a natural language paragraph, and performing dependency parsing on the natural language sentences to generate dependency relation data of the natural language sentences;
generating an integrated embedding vector for the natural language paragraph based on the natural language sentence and the dependency relation data; and
training a deep learning neural network based on the integrated embedding vector and a first coreference mention preset for the natural language paragraph to generate a coreference resolution model.

18. The method of claim 17, wherein, in the generating of the dependency relation data, the dependency relation data is generated by extracting the dependency relation between words included in the natural language sentence based on a dependency parsing result.

19. The method of claim 17, wherein, in the generating of the coreference resolution model, the integrated embedding vector is input to the deep learning neural network to generate a calculation result of the deep learning neural network, a mention is detected in the natural language paragraph based on the calculation result, a second coreference mention of the natural language paragraph is generated based on a result of the mention detection, and the coreference resolution model is generated by training the deep learning neural network based on the first coreference mention and the second coreference mention.

20. The method of claim 17, further comprising inferring a third coreference mention for the natural language paragraph input by a user using the coreference resolution model.
